(19) United States
(12) Patent Application Publication
(10) Pub. No.: US 2002/0159169 A1
(43) Pub. Date: Oct. 31, 2002

(54) Vehicle mirrors and related molds whereon the reflective surface is developed by a two-eye method involving the aniseikonia ratio ZETA of the left & right eye apparent image size pairs

(76) Inventor: Robert Charles McCord, Romulus, MI (US)

Correspondence Address: ROBERT C. McCORD, 6220 BURTON STREET, ROMULUS, MI, 48174, US

(21) Appl. No.: 09/811,705

(22) Filed: Mar. 18, 2001

(51) Int. Cl. G02B 5/08; G02B 5/10

(52) U.S. Cl. 359/868; 359/838; 359/853

(57) ABSTRACT

Vehicle sideview, rearview, and auxiliary mirrors; and molds, gages, and special tooling for making same are disclosed. These mirrors are comprised of flat, spherical, and aspherical optical surfaces, in combinations, as desired for any vehicle type or mounting position application. The mirror surfaces are developed as a function of certain Two-Eye optical characteristics concerning apparent image size and/or magnification factors between the two Eyes known as aniseikonia ratios, herein designated as ZETA. Desired ZETA ( [symbol] ) ratios are specified for the Two-Eye-Pairs across all or part of the mirror's surface, as the Vehicle Operator's lines-of-sight focus upon specified “Focus Lines” strategically located on either side of the vehicle. Aspheric Vehicle Mirrors, developed by the methods herein disclosed, have the propensity of becoming optically the most user-friendly possible for any given vehicle application, by selectively controling the apparent image size disparity as instantaneously observed by an Operator's two-Eye-pairs at any given point across the mirror's total viewing surface.

### CROSS REFERENCE TO RELATED APPLICATION

This invention involves automotive vehicle mirrors and relates to McCord's U.S. Pat. Nos. 4,449,786 and 5,980,050 and to McCord's current patent application with Filing date of May 1, 2000 (see Prior Art Search). This new invention concept utilizes vehicle operator lines-of-sight for development of wide angle fields of view wherein, for right side mirror's, optical control of the mirror's surface development is principally affected by application of aniseikonia (two eye) image ratios across the substantially horizontal portion of the mirror's surface beginning left to right, which ratios are equal to the horizontal apparent image size as seen by the right eye divided by the horizontal apparent image size as seen by the left eye, for respective right eye/left eye lines-of-sight pairs, while focusing upon an object at variable distances from the mirror, producing instantaneous simultaneous aniseikonia pairs of points across the mirror's surface. This concept applies as well to left side mirrors, whereupon the image ratios are taken from right to left.

### FEDERALLY SPONSORED RESEARCH OR DEVELOPMENT

Not applicable

### MICROFICHE APPENDIX

Not applicable

### BACKGROUND OF THE INVENTION

Proprietary concepts, Inventions, and patents, pertinent to elimination or reduction of automotive mirror systems blind-areas, have proliferated over the past fifty years, at once attesting to the seriousness and elusiveness of fundamental solutions for these basis problems. Mirrors are the simplest, least costly, and generally the most effective way to instantly and directly relate traffic conditions in the vicinity of a vehicle to it's operator. Yet, when attempts are made to measurably expand the field-of-view of a vehicle mirror or of various vehicle's mirror systems, serious optical difficulties are encountered.

Flat mirrors have been used since Barney Oldfield's early race car days, and provide the only mirror optics producing truly undistorted apparent images. But, the laws of physics cause flat mirrors to produce extremely narrow fields-of-view, which leave very large blind-areas on either side of an operators vehicle. In Oldfield's day, that wasn't a serious problem. But in today's very conjested multi-lane highway driving conditions, blind-areas contribute their share of unacceptable risk for accidents which cause serious property damage, bodily injury, and often human death. The only thing that can be done with flat mirrors, to increase their field-of-view, is to make them wider and/or taller, which has very distinct physical limitations.

Spherical convex mirrors have been used on automotive vehicles in the North American aftermarket beginning in the 1960's. Eventually, during the 1970's, spherical convex mirrors became optionally available and finally standard equipment on vehicles in the USA, with The National Highway Transportation & Safety Administration writing the pertinent rules applicable to all OEM vehicles manufactured or imported into the USA. These spherical convex mirrors are applied only to the passenger side of OEM vehicles, although spherical convex spot mirrors are often applied to both sides in the “aftermarket”. There are various trade-offs with application of these mirrors. the expanded field-of-view is exchanged for a reduced apparent image size. In most applications, the expanded field-of-view is helpful, but does not adequarely eliminate the blind-area. Generally speaking a field-of-view of 40 to 50 degrees, on either side of the vehicle, is necessary to adequately address the blind-area concerns. Most OEM spherical convex right side mirrors produce a field-of-view in the range of 25 to 35 degrees. Also, inherent to spherical convex mirrors, the apparent image size as seen by the vehicle operator is significantly reduced, which negatively impacts distance judgement. This problem is exacerbated as the object distance behind the vehicle is increased. Only two things can be done with spherical convex mirrors to increase their field-of-view, namely: 1) increase the size of the mirror, and 2) reduce the radius-of-curvature. Various negative conditions and limitations are associated with both of these options.

Aspheric convex surfaces, as applied to automotive mirrors, came under the scrutiny of two inventors (without knowledge of each other) during the mid-1970's, namely: 1) Stig Pilhall, Volvo Car Corporation, Sweden, and 2) Robert C. McCord, Independent Inventor, USA. Though used widely in Europe, principally on the driver side of passenger car applications, the Volvo concept was never patented anywhere in the world. The McCord concept is patented worldwide by the inventor, and is applied extensively in the USA “aftermarket”. In certain respects, the two concepts are similar, especially inasmuch as they both employ a spherical convex surface for a variable portion of the mirror nearest the vehicle operator. But for the aspheric surface, located beyond the spherical surface farther away from the operator to the peripheral edge of the mirror, the two concepts are very different. The Volvo concept employs exponential equations. This is a trial and error method for any new application, requiring considerable testing and evaluation to establish the best case. The McCord concept applies empirically derived line-of-sight equations. This method objectively develops the field-of-view to have desired expansion characteristics, for a given application, directly from the initial computer input/output. The McCord concept is currently applied to a wide range of vehicle applications including: Race Cars, Passenger Cars, Light Trucks & SUV's, Medium Trucks, and Heavy Trucks. Both concepts are successfully serving a purpose and need at this time. Basically, they both provide a flatter spherical convex portion than OEM spherical convex mirrors, consequently providing larger apparent image sizes which improve rearward distance judgement. The aspheric portions of both types, expand the field-of-view as desired, thus further reducing the net blind-areas. Nevertheless, there are certain optical characteristics of aspheric mirrors, relative to two-eye-vision (referred to as aniseikonia or binocular image disparity) that neither of these aspheric concepts have taken into account.

Most vehicle operators have two functional eyes. When they look at a vehicle mirror, while focusing upon a chosen object, lines-of-sight from the right and left eyes intercept and reflect from two different points on the mirror's surface. This condition is true if the mirror is flat, spherical convex, or aspherical convex. In the case of either flat or spherical convex mirrors, since the curvature” of the mirror's surface is constant, the apparent image size as seen by either eye is esentially identical. On the contrary, with aspherical convex mirrors, since the curvature of the mirror's surface is ever changing, the apparent image size as seen by the right and left eye is not the same. In the technical world, this latter condition is referred to as the aniseikonia ratio, which throughout this application is defined (for a right side mirror), when having reducing radius of curvature from left to right, as the ratio of: the right eye apparent image size divided by the left eye apparent image size=ZETA=( [symbol] ). For a left side mirror, the factors are reversed and are taken from right to left. In the case of either a flat mirror or a spherical convex mirror, the ZETA ratio always=1.000! But, for aspheric convex mirrors, assuming a right side mirror having increasing curvature from left to right, the ZETA ratio becomes<1.000! At some point, as this ratio continues to decrease due to progressive reduction of the mirror's instantaneous radius of curvature, the two eyes begin to see two distinctly different apparent image sizes. At some reduced ZETA ratio value, a two-eye/brain conflict develops, which usually produces undesirable physical symptoms for the vehicle operator. This condition derives from a number of factors, and is less tolerable for some vehicle operators than for others. These factors will be discussed in more detail under the heading “Summary Of The Invention”.

### SUMMARY OF THE INVENTION

The principal objective of this invention is to take into account the mirror's aniseikonia ratios, and indeed to develop part or all of the mirror's surface using predetermined ZETA ( [symbol] ) values and progressions to produce on average the most optically user-friendly mirror surface possible for any given type vehicle mirror application.

Another objective of this invention is to provide a family of unitary mirror surfaces for various vehicle applications, having the most user-friendly optical characterictics possible, developed by specifying and controlling the aniseikonia (two eye) image ratios ZETA, across part or all of the substantially horizontal surface of the mirror, while Integrating into this concept judicious rotational compression of the horizontally developed surface according to the teachings of U.S. Pat. No. 5,980,050, which will further expand it's usefulness in the downward vertical direction for many applications.

Development, testing, and highway use of various configurations of aspheric mirrors, as applied to automotive vehicles over the past twenty-five years or so, has brought these concepts to the threshold of critical analysis. Most human beings have two eyes that normally operate as a “cooperating pair”. When scanning an aspheric mirror, in the direction of a reducing radius of curvature, which for this presentation is in a left to right direction, an induced aniseikonia effect is produced wherein the two eyes see two different apparent image sizes while focusing upon the same object. The right eye, of course, sees a smaller apparent image size than does the left eye. As the ZETA ratio of the apparent images as seen by the two eyes reduces, a threshold of eye/brain strain limits is reached, which imposes various reactive symptoms upon the vehicle operator's brain. It must be noted that acceptable ZETA limits are not the same for everyone! Also many people, but not all, have one eye being dominant. For those who use “lazy eye glances” to the mirror, or for those having a distinctly dominant eye, or especially for those that have the use of only one eye, variably smaller ZETA value may usually be tolerated without accompanying eye/brain strain. And, for people whose left and right eyes are located closer together, lesser eye strain problems will be encountered, because their eyes lines-of-sight engage the mirror surface at closer points producing a larger ZETA value. Therefore, because of the many factors contributing to the combined aniseikonia effect, when specifying the mirror optical characteristics for a specific application, the ZETA ratio especially for the nearest half of the mirror should be held to 1.000 or as large as possible approaching 1.000. A further objective then of this invention is to control the aniseikonia effect, across the entire mirror's surface, in various ways that will optically eliminate or reduce the vehicle operator's potential discomfort while viewing the mirror.

One fundamental approach to designing an automotive mirror, while taking into account the aniseikonia effect, is to visualize the horizontal mirror face as divided into three sections from the side of the vehicle outward (say: 34%, 33%, and 33%). A more user-friendly proportion would be say (50%, 30%, 20%). The first section (nearest the vehicle operator) will then have a spherical convex surface, usually flatter than conventional automotive spherical convex mirrors, for the purpose of producing a larger apparent image size with accompanying improved object size, viewing acuity, and distance judgement; but having zero aniseikonia effect because it's ZETA values all=1.000. The second section will be developed to have a ZETA ratio gradually decreasing from 1.000 to about 0.900. The last section will be developed to have a ZETA ratio gradually decreasing from about 0.900 to whatever smaller value is necessary to produce a necessary or specified field-of-view (FOV) for a given mirror width and vehicle application. It is to be noted that the mirror face may be divided into any number of sections as found necessary to produce the desired optical characteristics, or a single functional equation may be used across the entire surface beyond section one. Ideally, the ending and beginning ZETA ratios, at the transition of one section to another, are to be substantially equal to each other to prevent instantaneous optical jerk. The ZETA ratios may also be varied as necessary to produce the best operator oriented optical results and/or manufacturing conditions for a given application. Though manufacturing conditions are considered, they are of secondary interest and importance, being associated with the “bending” or “molding” techniques used for forming the various base surface materials utilized, including glass and plastics, etc.

Another design approach, which accounts for the aniseikonia effect, is to develope the mirror's surface using progressively modified ZETA ratios, from the side nearest the operator to the farthest edge. Such a system might develope the nearest half of the mirror width using an optional ZETA value of 1.000, or 0.990, or 0.980, or 0.960, etc. The farthest half of the mirror's surface could then be developed using a lineally or exponentially changing ZETA value, wherewith the chosen ZETA factors will develope the specified total field-of-view. A variation of this method, that could work well for race cars and some other applications, would be to develope the entire horizontal surface of the mirror using linear or exponential ZETA factors, beginning with ZETA equal to 1.000 or some other suitable lesser value.

One reason that a number of design variations, proportions, and options are to be considered, when designing a mirror's surface using the aniseikonia ZETA concept of this invention, is that the nominal object distance from the mirror is one of the fundamental factors in determining the aniseikonia effect. In most cases such as side view mirrors, the nearest portion of a vehicle mirror must look long distances rearward, while the farthest portion must gradually see a vehicle or other object arriving immediately alongside the operator's vehicle into the “blind area”. But, in other cases, such as “look-down” mirrors located at the upper rear of many utility vehicles and school buses (which indirectly look down and behind the vehicle), and for fender mounted “crosss-view” mirrors as used on most school buses (which look down and in front of the vehicle), and for other fender mounted mirrors as used on heavy truck tractors (which look down and beside the vehicle), the object distance to the mirrors is relatively short. Designing mirrors for these various applications, each to have the most user-friendly optical characteristics possible, presents several distinctly different optical conditions and design requirements.

For race car applications, another interesting factor is to be considered. Generally, the whole object of racing is speed, as safely as possible—of course. This means that the vehicle operator has and will apply very little time (a small fraction of a second for any specific situation) viewing any mirror used on the vehicle. In such a case, smaller ZETA values may be acceptable, because the operator's main concern is whether an object is present rather than is the object in sharp focus. Moreover, race car drivers, particularity driving F1 and Indy Car open-wheel type vehicles, often use only the right eye to view right side mirrors and only the left eye to view left side mirrors, which essentially obviates consideration of the aniseikonia effect. Contrarily, for street and highway driving, vehicle operators often take much more time viewing their mirrors (in the range of 0.50 to 1.50 seconds—or more) and they usually use both eyes. Indeed, many operators probably spend too much time looking at and studying their mirrors, which of course robs forward viewing time and can cause other very serious up-front vehicle contact consequences.

The process of manufacturing an aspheric mirror of any type involves first making a suitable mold for the specific material to be used. Currently, glass mirrors are usually used for automotive vehicles, because of the materials stability under all types of environmental conditions. To a limited extent, plastic mirrors have also been used in certain after-market applications. However, new plastic compounds, treatments, and mirrorizing techniques, producing environmentally stable dimensional and scratch resistance qualities, offer the prospect that plastic materials could become prevalent in the near future, even on OEM vehicles.

For glass mirrors, “press bending” molds, comprised of male and female halves, are usually employed. Some lesser quality after-market automotive mirrors still use a single “slump bending” molding process, which typically employs a female mold only.

Plastic mirrors require the use of complex injection molds, which are much more costly to produce, though the piece price for the product is greatly reduced over the same item made from glass. And, of course, the use of plastic gives a significant weight reduction, which proffers a number of design application advantages.

In any case, whether glass or plastic or other material, a suitable mold is required to manufacture the mirrors. These molds, and/or mold sections, are made to the precise specifications of the mirrors to be produced. In the case of male/female pairs for glass mirrors, surface dimensions are made to compensate for the thickness of the glass to be bent. In the case of Injection molded plastic, etc., the molds are designed to produce the desired mirror thickness, which could vary across the mirror face if desired. The mirror specifications, produced by the processes disclosed in this invention, are also the exact specificastions for the male and female molds, dies, and gages, with thickness and buffer processing materials compensation as required.

In this invention, the aniseikonia ratio for a right side mirror is: the right eye apparent image size divided by the left eye apparent image size=ZETA=( [symbol] ). Since the apparent image size in a convex mirror is proportional to the magnification factor of the convex mirror compared to a planar mirror, it can be stated that the aniseikonia ratio for a right side mirror is: the magnification factor of the apparent image as seen by the right eye divided by the magnification factor of the apparent image as seen by the left eye=ZETA=( [symbol] ). These two ratios are identical.

The next task then is to determine and/or produce the instantaneous magnification (m) factor at any point across the mirror's surface. Moreover, there is reason to consider the magnification factors in both the horizontal and vertical directions, which may or may not be the same at any given point on the mirror's surface. Further, as with the horizontal factors, the vertical magnification factor for the right eye will usually (but not always) be different from the vertical magnification factor for the left eye. This brings two dimensional considerations into the aniseikonia ZETA processes of this invention. We will here present the simpler case of only horizontal aniseikonia ZETA considerations, since the vertical process is very similar, and combines the two into an exponential (or area) ZETA value, simulating the frontal area of an object as viewed by the Vehicle Operator, according to the teachings of this invention.

PHYSICS HANDBOOK MIRROR EQUATIONS AND DERIVATIONS FOR HORIZONTAL, VERTICAL, AND COMBINED ZETA VALUES:

$$\frac{1}{p} + \frac{1}{q} = \frac{2}{r} = \frac{1}{f}$$

TRANSFORMED:

1/p+1/q=2/r=1/f;

WHERE:

p=distance of object from mirror at point of interest on mirror

q=distance of image from mirror at point of interest on mirror

r=instantaneous radius of curvatre of mirror at point of interest on mirror

f=instantaneous focal length of mirror at point of interest on mirror

AND:

m=d [symbol] d_{O}=(-r)/(2p-(-r)); m_{R}=d _{R} [symbol]/d_{OR}; m_{L}=d_{z,901 L}/d_{OL}

WHERE:

m=d_{z,901} /d_{O}=magnification factor=ratio of apparent image size to object size

d [symbol] =dimension of apparent image in miror

d_{O}=dimension of object

m_{R}=magnification factor as seen by the right eye

m_{L}=magnification factor as seen by the left eye

d _{R} [symbol]=for right eye—dimension of apparent image in mirror

d_{OR=for right eye—dimension of object}

d [symbol] L=for left eye—dimension of apparent image in mirror

d_{OL}=for left eye dimension of object

d_{H R} [symbol]=dimension of horizontal apparent image as seen by the right eye

d_{H L} [symbol]=dimension of horizontal apparent image as seen by the left eye

m_{HR}=horizontal magnification factor as seen by the right eye

m_{HL}=horizontal magnification factor as seen by the left eye

d _{R} [symbol]=dimension of vertical apparent image as seen by the right eye

D_{V L} [symbol]=dimension of vertical apparent image as seen by the left eye

m_{V R}=vertical magnification factor as seen by the right eye

m_{V L}=vertical magnification factor as seen by the left eye

m_{GR}=longitudinal magnification factor as seen by the right eye

m_{GL}=longitudinal magnification factor as seen by the left eye

ZETA=( [symbol] )=ratio of Right Eye/Left Eye or Left Eye/Right Eye (of image dimension or mag factors)=d_{z,901 R}/d _{L} [symbol]=m_{R}/m_{L}; OR=d _{L} [symbol]/d _{R} [symbol]=m_{L}/m_{R}

THEN (FOR A RIGHT SIDE MIRROR):

( [symbol] _{H})=d_{H R} [symbol]/d_{H L} [symbol]=m_{HR}/m_{HL}: Linear horizontal ratio of ( [symbol] )

( [symbol] _{V} )=d_{V R} [symbol]/d_{V L} [symbol]=m_{V L} [symbol]: Linear vertical ration of ( [symbol] );

( [symbol] _{E})=(_{R})²/(_{L}): Exponential Area approximation ratio of ( [symbol] );

( [symbol] _{A})=((_{HR})(_{V R})/(_{HL})(_{V L})): Simulated Viewed Area ratio of ( [symbol] );

( [symbol] _{G}):((_{HR})(_{V R})(_{GR})/(_{HL})(_{V L})(_{GL})): Simulated Volume ratio of ( [symbol] )

AND (FOR A LEFT SIDE MIRROR): The (R) and (L) subscripts are reversed.

### DESCRIPTION OF DRAWINGS

Ten Figures are provided in this section, using like characters throughout.

FIG. 1 is a birdseye (plan) view of three adjacent and parallel Inter-State State highway type lanes, each approximately twelve feet wide and traveling in the same direction. A principal vehicle 10 (van type) is shown in a forward position in the center lane. A passenger car 11 is shown in a trailing position in the center lane as well. In the immediate normally “blind-area” location in the right lane, a motorcycle 12 is shown. In the right lane, behind the motorcycle, a tractor 13 trailer 14 combination is shown. In the left lane a large highway type bus 15 is shown. The principal vehicle 10 is provided with side-view mirrors left 16 and right 17, having binocular aspheric optical characteristeis as defined by this invention. The head 18 of the principal vehicle's operator is shown with left 3 and right 4 lines of sight from his/her eyes to the mirrors. Six pairs of reflected sight rays 5 are shown from the left mirror, and six pairs of reflected sight rays 6 are shown from the right mirror. In both left and right mirror cases, one pair of reflected rays 1 & 2, respectively, are directed straight rearward. All other reflected sight rays 5 from the left mirror are focused upon an imaginary oblique “focus line” 7, located in the left lane; while all other reflected sight rays 6 from the righr mirror are focused upon the centrally located parallel imaginary “focus line” 8, located in the right lane.

FIG. 2 is an enlarged plan view of the right side mirror 17 shown in FIG. 1. Six lines of sight 22 from the principal vehicle 10 operator's left eye 20, and six lines of sight 23 from his/her right eye 21 are shown to the mirror's surface. Left eye points of reflection from the mirror's surface 17 are identified as L0, L1, L2, L3, L4, & L5. Right eye points of reflection from the mirror's surface 17 are identified as R0, R1, R2, R3, R4, & R5. The reflected lines of sight occur in pairs as shown here and in FIG. 1, namely: (L0-R0), (L1-R1), (L2-R2), (L3-R3), (L4-R4), (L5-R5). The left 26 and right 27 lines of sight of the (L0-R0) pair are reflected parallel to eachother and substantially straight rearward. The other five pair of reflected lines of sight are focused on the right lane “focus line” 8, as shown in FIG. 1. These six pair of reflected lines of sight are randomly shown from hundreds of pairs used to develope the optical structure of the mirror's 17 surface. Nominally, the average eye distance EYD may be used as 65 mm (2.56 ins) as specified by the SAE J941 Standard. For critical application of the concepts of this invention, it may be preferable to use the eye distance as 70 mm (2.76 ins). For graphic purposes, and because of paper space limitations, the eyes are shown much closer and out of proportion to the mirror than in real applications. Neck rotation center 28 is shown.

FIG. 3 is a birdseye (plan) view of three adjacent and parallel Inter-State State highway type lanes, each approximately twelve feet wide and traveling in the same direction, as depicted in FIG. 1. A passenger car type vehicle 30 is shown in the center lane. The inside rearview mirror 31 of this passenger car is shown. The head 32 of the vehicle operator is shown, with lines of sight 33 from his/her eyes to the mirror. Seven pairs of reflected lines of sight are shown, with one pair substantially rearward 34, three pairs to the left side 35, and three pairs to the right side 36. Those pairs of sight lines, to the left, are each focused upon an imaginary “focus line” 37, which is displaced parallel toward the vehicle from the center-line of the left adjacent lane. Those pairs of sight-lines, to the right, are each focused upon an imaginary “focus line” 38, which is displaced parallel away from the vehicle from the center-line of the right adjacent lane.

FIG. 4 is a graph showing a family of curves which represents the instantaneous radius of curvature (ROC) of a full range of convex mirrors. These values may be used for either: spherical convex mirrors at any point across the mirror face, or for aspheric convex mirrors at specified instantaneous points across the mirror face. This family of ROC's show the magnification factor value (m) for a specified mirror ROC (r) at a given object distance (p) from the mirror's reflective surface. The formula for the magnification factor is given as:

$$m = [ \frac{( - r )}{2 p - ( - r )} ] = [ - \frac{r}{2 p + r} ]$$

WHERE:

m=magnification factor of object as seen in the mirror by the vehicle operator

p=the object distance to the mirror face

r=instantaneous radius of curvature of the mirror's surface

Magnification factors (m) are shown along the left margin, ranging from zero for a ROC value of zero, to 1.0 for a ROC value of infinity for a flat (planar) mirror. Cursory analysis of these graphs shows that, in the range of (r=20″ to 100″), most of the (m) factor reduction occurs in the range of (p=0′ to 30′). This is the most critical Vehicle Operator's area of concern. Nevertheless, (m) vrs the (p) distance is taken into consideration all the way to infinity from the mirror's reflective surface, according to the teachings of this invention.

FIG. 5 shows six right hand automotive side view mirror face options, labeled A, B, C, D, E, and F, taken from an unlimited array of possibilities. For options A through E, the optical datum center labeled ODC, is the zero starting point for aspheric curvature of the mirror's surface; which is a rotational generation of X (horizontal) and Y (vertical) values, all of which are rotated about the point ODC. Mirror face option F utilizes a linear Optical Zero Datum Line, as shown. The surface contour lines shown on each mirror face, as they progress toward the outer edge of the mirror, represent increasing curvature away from the ODC or Zero Datum Line. The surface curvatures of these mirror options are all developed according to the teachings of this invention. It is to be noted that the ODC or Zero Datum Line may be located at the edge of the mirror face, off the mirror face, or on the mirror face, as desired for various applications. Relatively simple two-axis linear or two-axis rotational machinery is adequate to cut the molds for these type of mirrors.

FIG. 6 shows a right hand automotive mirror application having complex three dimensional optical surface characteristics. A Horizontal Datum Axis is shown passing through the ODC. This mirror's surface, on and above the Horizontal Datum, is constructed as those mirrors shown in FIG. 5. The mirror's surface, below the Horizontal Datum, is elliptical as shown (or otherwise) compression of the surface characteristics above said Datum and depends therefrom with continuous optical comparability. The upper portion of this mirror's surface is classified as concentrically aspheric. The lower portion of this mirror's surface is classified as nonconcentric compressed aspheric. Because of the complex nature of this compressed aspheric portion, three dimentional (three axis) machinery, driven by sophisticated “MasterCam” software (or equivalent) is required to cut the molds for this surface configuration. The teachings of this invention are also hereupon applied.

FIG. 7 shows the face of a typical passenger car inside rearview mirror. Surface contour lines, as depicted in FIGS. 5 and 6, are shown on this mirror's face as well. The ODC is shown approximately in the center of the mirror, but can be located otherwise as design requirements dictate. The surface contours of this mirror are developed concentrically about the ODC as shown. The center portion of the mirror is shown as being spherical (though it could employ gradual aspheric development). Left and right aspheric areas are shown. Due to the different characteristics of vision and reflected lines of sight for the left side of the mirror vrs the right side, the aspheric surface structure of the left and right sides are normally not the same (though they could be under certain circumstances). This mirror's surface is developed according to the teachings of this invention.

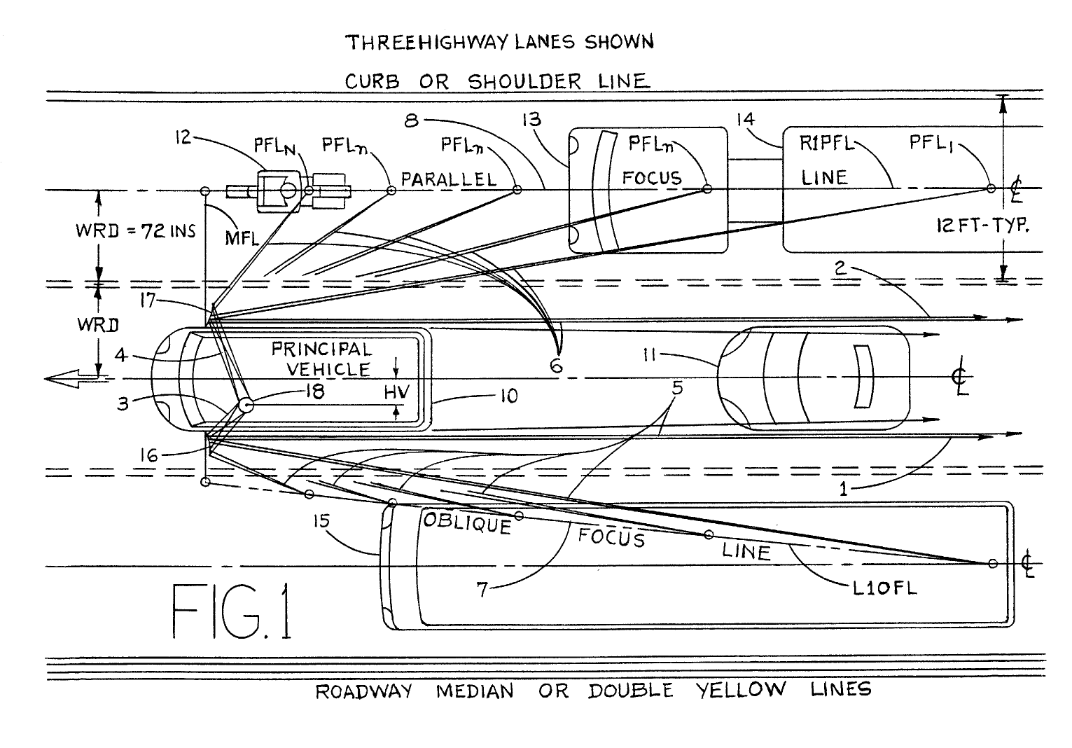

FIG. 8 is a basic cross-section of a typical right hand mirror piece and it's mold configuration, as taken from FIGS. 5C or 5E or FIG. 6, which show the ODC to be on the mirror face. Shown are relationships between the mold, the oversized glass blank, a maximum mirror piece that can be “cut” from said glass blank, and a typical mirror piece (section shown in solid black). Eye sight-line pairs are shown scanning the entire width of the mirror piece. Parallel left eye/right eye sight-lines, straight rearward to infinity (the horizon) are shown, emanating from the ODC point. One pair of sight-lines, inboard of straight rearward, focus upon the side of the operator's vehicle. Those sight-line pairs, shown beyond those of straight rearward, converge upon a specified “focus line” as shown in FIGS. 1 & 3. The “X” and “Y” axes, used for construction of the mirror's cross-section, are normal to eachother and pass through the ODC=L0, with the “Y” axis tangent to the mirror's surface at that point. For graphic purposes, the eyes are shown much closer to the mirror than in real applications. The peripheral portion of the mirror, outward from the observer and beyond the maximum mirror piece extention line, shows increasing radius of curvature, which is necessary for glass bending and fabrication. For Injection Molded Plastic Mirrors, curvature beyond the maximum mirror piece extention line may increase as desired (and as shown). In other words, smaller radius-of-curvature and greater surface slope angles may be used for plastic mirrors, since there is no “bending” restriction.

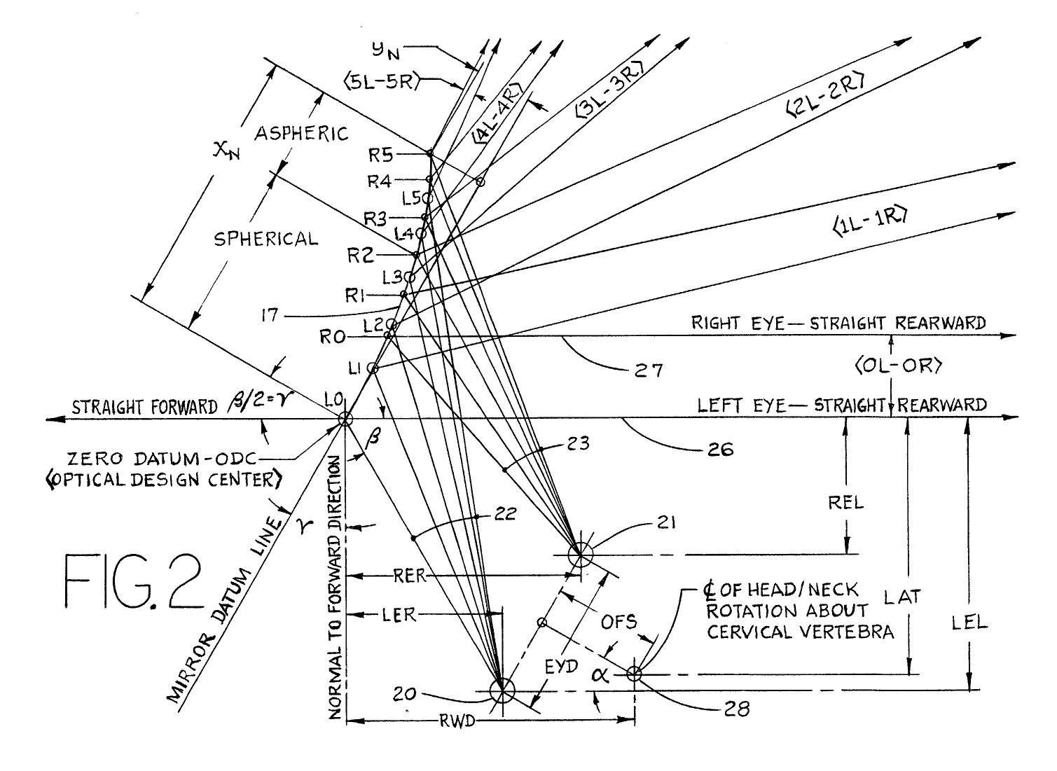

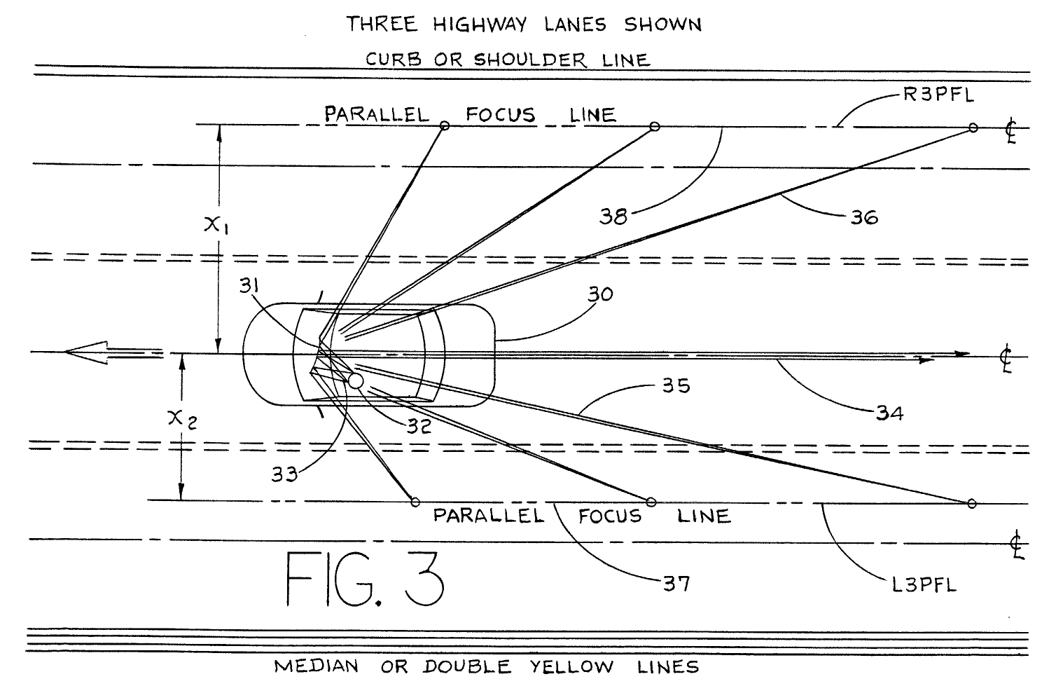

FIG. 9 is a modified version of FIG. 2, deleting some of it's general detail for clarity. This Figure shows the additional optical geometry and trigonometry necessary to develope the mirror's reflective surface through the iterative process across the entire mirror's width, including the first spherical portion and the final aspherical peripheral portion. Like elements use the same number identification as FIG. 2. ROC_{LO}, ROC_{RO}, and ROC_{R2}, are all equal to each other, being part of the same spherical convex surface. All ROCvalues beyond R2, are progressively less than ROC_{R2}. In this diagram, ROC_{R5} is the smallest radius-of-curvature on the surface. L0=ODC is the Optical Design Center for all calaculatios on the mirror's surface. This Figure is necessary to implement the iterative process of the Preferred Embodiment of this invention, and is fundamental for any application of these concepts.

FIG. 10 shows a diagram of ( [symbol] ) ratio values and options, which occur and are provided to iteratively develop the horizontal portion of the mirror's surface. The formula for these values is: ( [symbol] _{H})=(m_{HR}/m_{HL}). Points along the mirror's surface L0, R0, R2, AND R5 (FIG. 9) are shown. L0-R2 is the spherical portion of the mirror. R2-R5 is the aspherical portion of the mirror. L0 and R0 are reflective points on the mirror's surface straight rearward from the Left Eye and Right Eye, respectively. ( [symbol] _{H}) ratio values are shown, beginning with (1.0000) along L0-R0, and are measured in the vertical direction. As the mirror's surface is iterated, the ( [symbol] _{H}) values progressively decrease. This occurs naturally across the spherical portion due to increasing obliqueness of the Δθ sight-lines relative to the mirror's surface. Decrease of ( [symbol] _{H}) values across the aspherical portion is induced by introduction of (K) factors, which cause increasing curvature of the mirror's surface and thereby controlled increasing field-of-view. In development of the mirror's surface, (K) factors are subtracted from (1.0000) to produce the new ( [symbol] _{H}) values at any point along the surface. The formula is: ( [symbol] _{H})=(1.0000-K). Three optional ( [symbol] _{H}) value change rates are shown across the aspherical portion R2-R5 of the mirror's surface. The Option-3, Exponential Form, is preferred.

### DESCRIPTION OF A PREFERRED EMBODIMENT

General Specifications

Depending upon specific applications, such as Race Cars, Passenger Cars, and Heavy Trucks, etc.; and depending upon field-of-view and optical characteristics desired, there are several preferred embodiments. The concepts and procedures for developing Driver side, Inside, and Passenger side mirror applications are all very similar. The preferred embodiement described herein is for a RIGHT SIDE VAN or SUV mirror. The procedure develops as follows:

A Van or SUV type vehicle 10 as shown in FIG. 1, will be provided with a right side mirror according to the concepts of this invention. The expanding field-of-view requirements will be similar to those as shown in FIG. 1 and FIG. 2 for this type vehicle. The width of the usable mirror face is specified as 9.50 inches; the height of the mirror face is specified as 7.00 inches (not shown). FIG. 2 is an enlargement view of the Operator's 18 left eye 20 and right eye 21 sight-lines to mirror 17 as shown in both FIG. 1 and FIG. 2. In FIG. 2, the X_{N} design width dimension will be made=9.00 inches, beginning at the point ODC=L0, which is referred to as the Optical Design Center of the mirror. This allows the first half inch (nearest the Operator) of the mirror's total usable width to be used for looking at the right side of the Operator's vehicle 10 providing visually connected reference to the vehicle's immediate surroundings.

Spherical Convex First Portion

A portion of the mirror's surface (nearest the Operator) will be specified as spherical convex. By specifying the point on the mirror's surface identified as R2 to be the transition point between the spherical portion and the peripheral aspheric portion, in this case we will dedicate approximately ⅔ of the mirror's surface to be spherical. In various practial applications, this spherical/aspherical proportion may be varried in either direction without limits. For this embodiment we will use 100 inch radius-of-curvature (ROC) for the spherical portion, which has proven very acceptable for many vehicle applications. The remaining portion will be developed according to the expanding characteristics of the biocular aniseikonia ZETA ( [symbol] ) ratio concepts of this invention.

The next step is to establish the geometric and coordinate relationships between the mirror and the Operator's Eyes, when the Operator's head is turned so as to observe the mirror face. The Society of Automotive Engineers (SAE) Standard J941 is an excellent place to derive this necessary information; although for some applications, the information may be derived from other sources or may be acquired empirically. In FIG. 2, dimensions LAT, RWD, and Neck/Head/Eyes rotation α are functions of each specific Vehicle and Operator's driving habits. Likewise, SAE J941 also provides data for the Operator's Neck Offset OFC, and Eye Center Distance EYD. For OEM applications, the SAE data is the correct way to go, which makes necessary compromises for “average” conditions and median Operator positions, etc. For aftermarket applications, where the same mirror face geometry may be used for an array of vehicle applications, broader average application compromises are necessary; nevertheless, this concept applies very user-friendly in all cases. Dimensions LEL, LER, REL, RER, OFS, AND EYD will locate both the left Eye 20 and the Right Eye 21 relative to point ODC on the mirrors reflective surface.

To correlate the Operator's sight-lines in FIG. 1 and FIG. 2, of which both figures are required to comprehend the concepts of this invention, it is noted that in FIG. 1 the sight-lines 4 are for both the left and right Eyes. In FIG. 2, the same sight-lines are identified as 22 for the Left Eye, and 23 for the Right Eye. Although in the computerization of this process, 100 (more or less) sight-line iterations per inch of mirror width will be executed in the beginning phase, only six sight- line pairs are shown across the whole mirror face in these figures for graphic, optical, and mathematical clarity.

The Optical Design Center ODC is also identified as point L0 on the mirror's surface. Line 26 is reflected straigh rearward from sight-line 20-L0. There are several attitudes of head rotation that may be implemented at this point, any of which will suffice to begin execution of the continuing processes of this invention. (Note: For driver-side applications, most cases would find the Head rotation to be approximately 30 degrees to the left. The Right Eye line-of-sight would then be approximately normal to that Mirror's Datum Line. However, for the passenger side, conditions are quite different since this mirror is two to four times farther from the vehicle Operaror than is the driver side mirror.).

For this passenger side embodiment, the Head rotation will also be approximately 30 degrees, but the Eyes line-of-sight will not even come close to being normal to the Mirror's Datum Line. The Left Eye 20 will rotate approximately another 30 degrees to the right, at which point it's line-of-sight will intercept point L0 (the optical datum) on the mirror's surface. Head rotation is shown as α. The Left Eye total rotation from straight forward is shown as β, which is the sum of (Head+Eye) rotation. Analysis and calculation of the mirror's surface X and Y coordinates will begin as soon as the relationship between the Operator's Eyes and point LO have been established. The Head/Neck 28 and Eyes 20, 21 positions are established by dimensions LAT, RWD, OFS, and EYD, which are a function of the type(s) of vehicle(s) being considered and the Operator being a person of average stature as determined by the SAE J941 Standard or other means. It is to be noted that, for the purpose of these calacultions, the average Eye Ball will be taken as one inch in diameter. All line of sight dimensions will be taken from the center of the Eye Ball. Sight-line 20-L0 may now be trigonometrically calculated. The process of iterating and developing data for the spherical portion of the mirror's surface may now begin.

The task at hand is to solve a lagre number of oblique triangles with the objective of producing a progressive series of ZETA ( [symbol] ) ratio values as the two Eyes scan the mirror's surface horizontally from left to right for this right hand mirror. All of these calculations are based upon a progressive series of paired Eye relationships at specific points of interest on the mirror's surface. Many of the formulas and factors necessary for making these calculations are found under Summary Of The Invention, pages 12 and 13.

From page 13, ( [symbol] )=(d_{H R} [symbol]/d_{H L} [symbol])=(m_{HR}/m_{HL}), are the relationships of interest to us. The (d/d) represents the ratio of the apparent image size as seen in the mirror by the Right Eye divided by that as seen by the Left Eye. This ratio is of little practical value to us because these factors can only be measured under laboratory conditions. On the Contrary, (m_{HR}/m_{HL}) represents the ratio of the magnification factor of the apparent image seen in the mirror by the Right Eye divided by that seen by the Left Eye, which are easilly attained and are necessary for execution of these concepts.

The formula for the magnification factor (m), at any point across the mirror's surface, is given as: m=(−r)/(2p−(−r)). We have given, or can calculate, values for both (r) and (p) at any point across the mirror's surface. Specifications for (r) begin constant at (100″ ROC) across the spherical portion and becomes variably decreasing across the aspheric portion. And (p) is the length of the reflected light ray from a specific point on the mirror face to a target point on the FOCUS LINE. In this case the center line of the adjacent traffic lane is the specified FOCUS LINE, as shown in FIG. 1.

The iterative process to be used here is somewhat similar to that shown in U.S. Pat. No. 4,449,786. Specifically, we will be iterating constant line-of-sight vision angles Δθ from the Operator's Eyes to the mirror. In this case, for a right side mirror, iterations begin with the leading Right Eye 21, remembering that herein all iterations are done as Right Eye 21/Left Eye 20 pairs. FIG. 9 is a replication of FIG. 2 showing specific iterative points, conditions, and processes. Angle β is calculated based upon the requirement that reflected line 26 is caused to reflect straight rearward from point LO on the mirror's surface. The angle γ=β/2 then establishes the directional attitude of the Mirror Datum Line 24, along which all X-Y coordinates defining the mirror's surface are measured beginning at point L0. Line 29 (00-L0) is perpendicular to line 24, and is the (100″ ROC) base line for the spherical portion of this mirror, emanating from point 00. By an iterative loop process, the point R0 on the mirror's surface is next found, which reflects line 27 straight rearward parallel to line 26.

For data and calculations along the mirror's surface, for both the spherical and aspherical portions, including information such as X-Y coordinates, and instantaneous slope angles θ, etc., solution of a series of oblique triangles involving basic trigonometric calculations are performed. For the spherical portion, X-Y coordinates, etc., can be determined for any point along said surface simply by knowing the ROC and the γ inclination angle of the Mirror Datum Line-24. Arc-chords c, between any two adjacent points along the mirror's surface during the iterative processes, are measured and specified as straight lines. The oblique triangles, requiring our attention, are formed by respective arc-chords and any two adjacent sight-lines which comprise the respective Δθ vision-angles subtending said chords throughtout the iterative process. Instantaneous slope angles θare equal to the slope of respective chordal elements cwith respect to the Mirror Datum Line-24. It is to be noted that the exact instantaneous slope angle of the mirror's surface is located at any respective chordal end point, and is not the slope of the chord itself. But this academic fact is of no concequence relative to the end objectives of these iterative processes. These oblique triangles may be solved using the Law of Sines, Cosines, and/or Tangents, and may involve simultaneous equations and/or various iterative proceses. Note: SUBS values represent randomly specified iterative points across the mirror's surface. SUB_{N} represents the last iterative point on the mirror's surface, or in a specific iterative series.

We will now calculate the constant line-of-sight vision angle Δθ, which becomes the basis for all iterations across the entire mirror's surface. The exact value of this angle is unimportant, but only that it remains constant across the mirror's surface. Assume Δθ to subtend a mirror surface chord c=cr0 of (0.01 inch) beginning at point RO. This relatively small value is chosen for several reasons, namely: 1) To allow tool makers, using CNC machinery, to produce smooth (stepless) contours for both molds and gages; 2) To anticipate the increasing chordal length, in the peripheral area of the mirror, as the slope angle (θ) increases substantially while subtended by the constant Δθvision-angles. Surface chords capproaching widths of (0.05 inch) are becoming excessive to produce acceptable mold and gage contours, and should be avoided. If encountered, reiterate the entire surface, starting with a smaller Δθ value proportional to the desired ctarget.

For this right side mirror, iteration of the mirror's surface begins with the Right Eye 21, at point R0. Beginning at point R0, oblique triangle ar0-br0-cr0 is formed by the sides of the Δθ-vision angle. Using cr0 32 0.01″, said triangle is solved. Reflected line pR1 emanates from point VR1, terminating at Parallel Focus Line R1PFL (FIG. 1) at point PFL1. Referring to FIGS. 1 and 2, line R1PFL is related laterally to any point on the mirror's surface through various dimensions that are given, asumed, or calculated. Therefore, a Right Triangle pr1-MFL1-R1PFL1 is formed. Knowing the side MFL1 and the angular direction 6, of the reflected line-of-sight pR1, the length of pR1 is determined. The longitudinal distance rearward from the mirror of point PFL1 is then calculated as R1PFL1. The point PFL1 becomes the target for a reflected line-of-sight from the Right Eye pL1. A looping iterative process is necessary to find the precise point on the mirror's surface that causes pL1 to intercept point PFL1.

The next step is to calculate the magnification factors for both the pR1 and pL1 sight lines, which are designated as mHR1 and mHL1, respectively. The magnification formula is: (m)=(−r)/(2p−(−r)). For the spherical surface, since (r) is constant, it is readily seen that (m) depends solely upon the respective values of (p). At this beginning point on the spherical surface, the reflected rays pR1 and pL1 are of almost infinite length, consequently the mHR1 and mHL1 values will be virtually nil and equal. In this case, as we iterate about two-thirds across the mirror's width as spherical, a small but increasing difference will develop between the lengths of pRn and pLn.

It is now time to calculate the ( [symbol] ) ratio of the Right and Left Eyes reflected sight rays. The ZETA formula is: ( [symbol] _{H1})=(mHR1/mHL1). These values will begin as (1.0000), but will gradually reduce to some lesser value as we iterate the designated spherical surface to point R2=ZR0. All of the data values, generated in the total foregoing iterative processes, will be stored in computer memory for later use, including the incremental iterative ( [symbol] _{H}) values.

Aspheric Convex Peripheral Portion

Once we reach point R2 on the mirror's surface, which is the end of the spherical portion, the iterative process changes significantly. Beginning at point R2=ZR1 and proceeding to R5=ZRN, we will generate the aspheric peripheral portion of this mirror as a function of a changing ZETA ratio, as shown in FIG. 10. A principal objective is to monitor the ( [symbol] ) ratio values, which begin in the first part of the spherical first portion with ( [symbol] _{HO}=1.0000), because both eyes are focusing on an infinitely distant target. As the iterations progress across the spherical portion, the ( [symbol] _{H}) values begin reducing slightly, becoming less than 1.0000 at the spheric/aspheric transition point R2.

For the best optical dynamics, and bending characteristics for glass mirrors, it is important that there be no optical “jerk” at the spheric/aspheric transition point R2. FIG. 10 gives us three options to cross the R2 transition line. In all three cases, it is necessary to calculate the slope angle (λ), of the progressive ( [symbol] _{H}) ratio factors ending at R2. Then the three or any other options, for ( [symbol] _{H}) crossing the R2 transition line, should be tangent to (λ) at that point.

Option-1, having a straight-line tangent to (λ) at R2, is the simplest geometry, but in most cases will not develop the desired total field-of-view for a given application.

Option-2, with a circular-arc transition at R2 and a straight-line tangent to the circular-arc, can be made to work for any application and is a good choice.

Option-3, having an exponential curve transition at R2 with it's flattest part at R2 and it's most curved part progressively towards the mirror's peripheral edge, is the best optical choice. This method moves more of the Two-Eye Eye optical image-size disparity towards the peripheral edge, farther away from the vehicle operator Eyes, and is specified for this Preferred Embodiment.

When the Two-Eye image size disparity reaches about 8% (ie: ( [symbol] _{H}=0.9200) it is estimated that a majoity of vehicle oprators will experience various measures of Eye discomfort, especially when first exposed to this concept and particularly if they “stare” directly at the peripheral mirror portion. Therefore, one objective of this invention is to provide the most direct method possible of tailoring the optical application for user-friendliness. This is accomplished by designing the optical characteristics of the mirror to progressively and precisely locate the maximum optical disparity to the peripheral edge of the mirror toward ZRN, if possible restricting ( [symbol] ) values less than (0.9200) to the peripheral 10% of total mirror width. In the process, the preceeding portion is carefully controlled so as to gradually approach that area and point of greatest ( [symbol] ) ratio values.

The iterative process begins by assigning new identity to the vison angle triangle elements at the R2 transition point. brN becomes dr0, er0 is the next sight-line, and crN goes to fr0. It is to be noted that the leading sight-line brN, of the last iteration, becomes the trailing sight-line dr0 of the current iteration. Also, crN is the last chordal element along the spherical portion and fr0 is the first chordal element along the aspherical portion.

The first trial selection of fr0 is made to be a percentage larger (say 1%) than the preceding chordal element (ie: fr0=1.01 X crN). This assures that the slope of fr0 wiil be greater than crN, accelerating the increasing field-of-view as well as the ( [symbol] ) ratio value. Triangle (dr0-er0-fr0) is solved by the law of sines. Point ZR1 is established; and the angular direction and length of reflected sight-line pRn, therefrom, is calculated to it's intersection point on Focus Line R1PFL, which is PFLn. The Left Eye line-of-sight is next reflected, and length calculated, from that point on the mirror's surface that causes it to intercept this current point PFLn on the Focus Line.

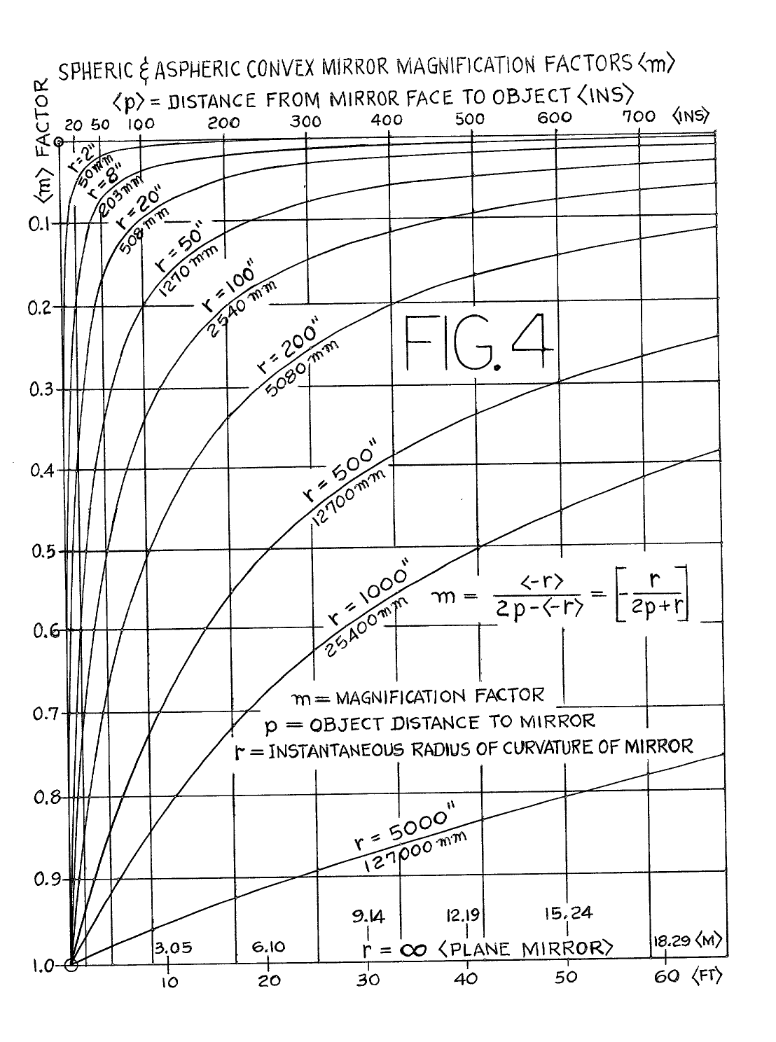

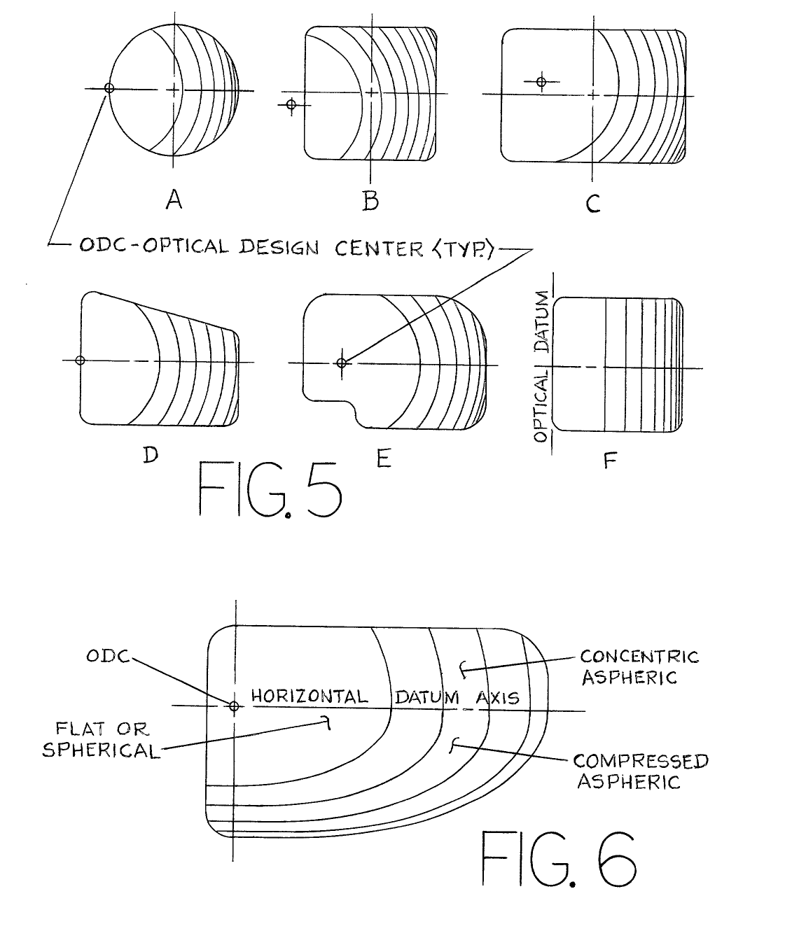

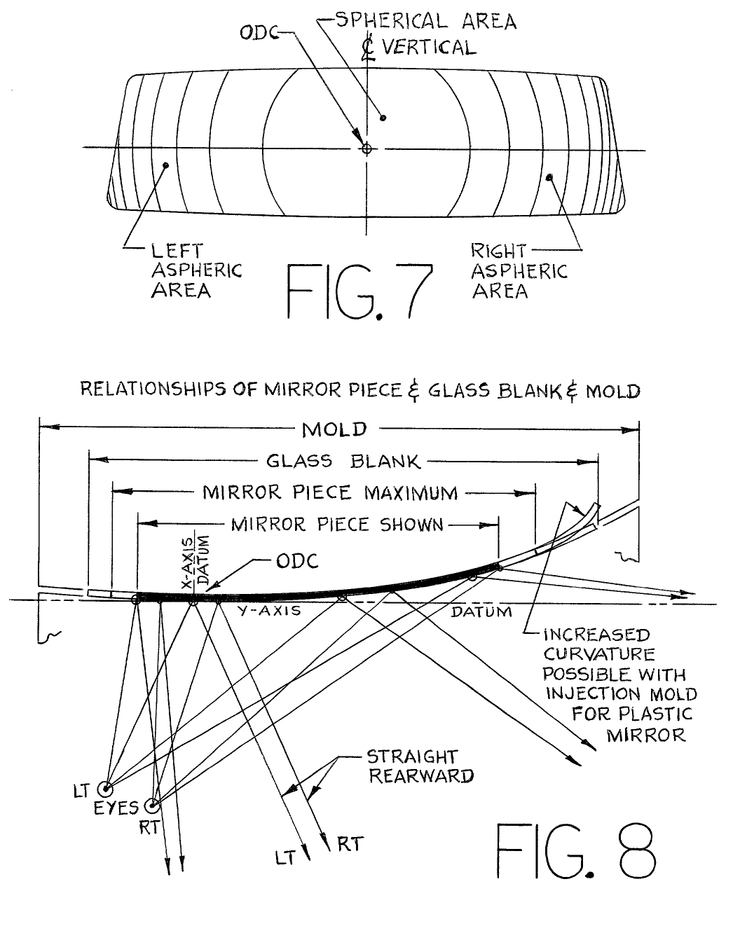

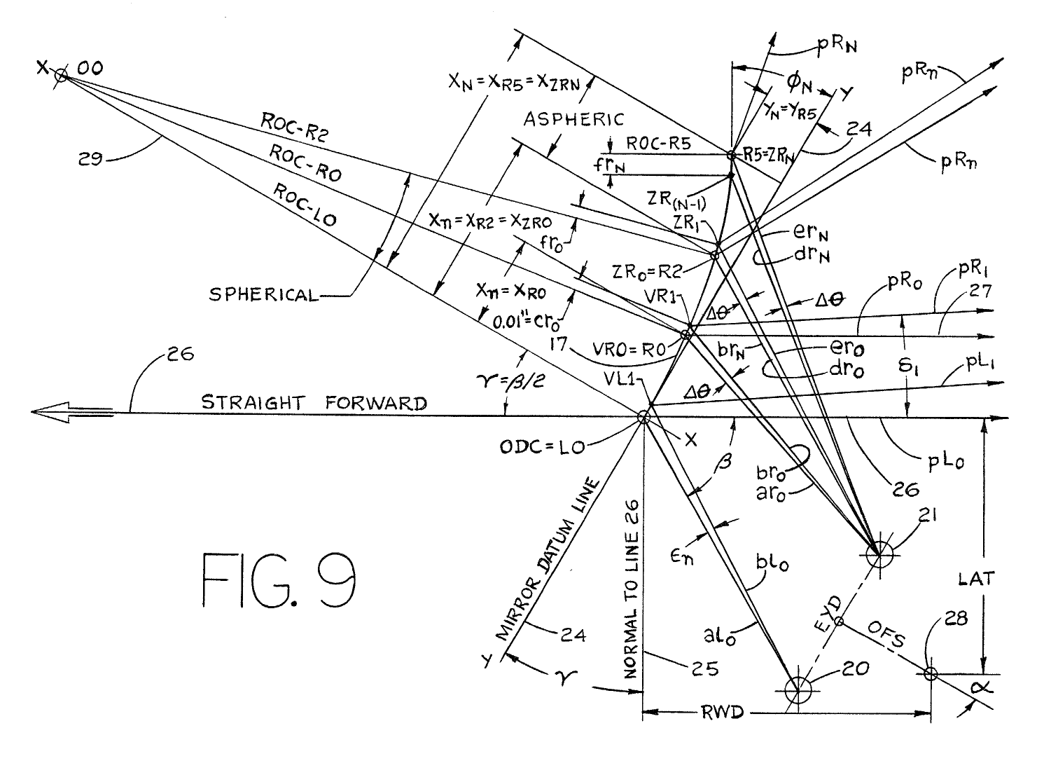

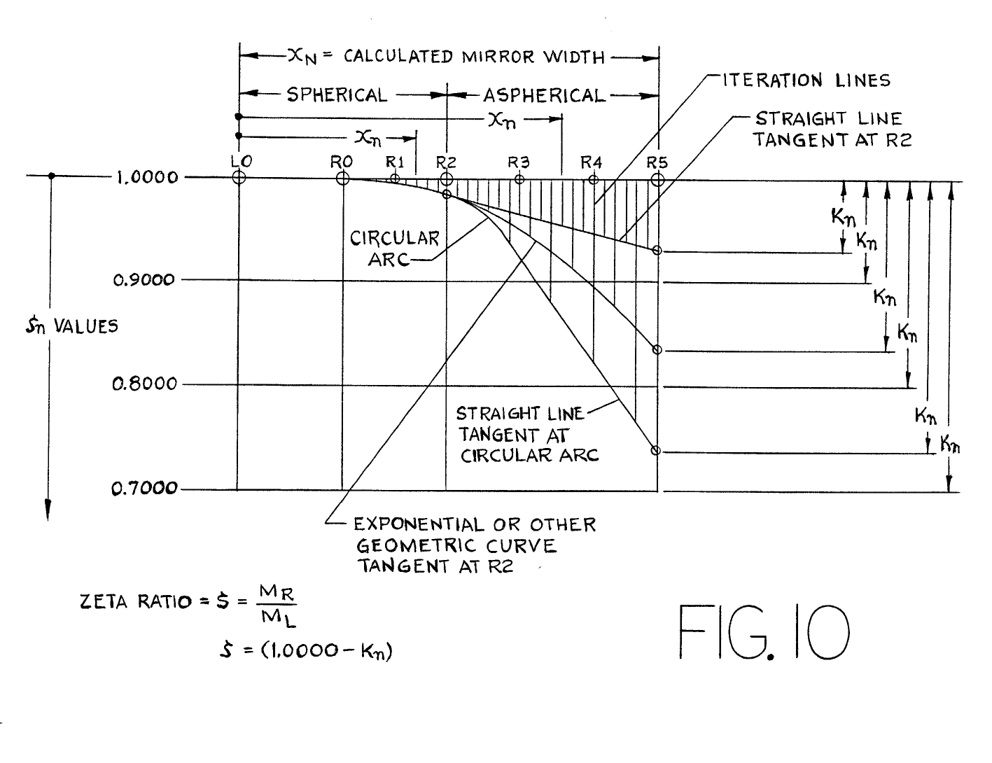

The magnification factors mHRn and mHLn, for right and left Eyes, respectively, are calculated; using the formula for calculating (m) as given in FIG. 4, which is: m=(−r)/(2p−(−r)).

At this point, the ZETA ( [symbol] ) ratio between the two Eyes is calculated. A number of formulas for calculating this ratio are possible. Each formula will produce somewhat different rates of curvature change across the mirror's surface, but all will produce usable end results. Formulas expressed in this Preferred Embodiment description relate to various optical ways of considering the object(s) being viewed, including: horizontal (linear only), simulated area approximation (two dimensional), simulated viewed area (two dimensional), and simulated volumetric (three dimensional—oblique attitude). Other exponential equation relationships may also prove advantageous. Various vehicles have different mirror widths and other considerations for which, in each application, the best optical transition will be dictated, respectively. Four optional formulas are given:

( [symbol] _{H})=(m_{HR}/m_{HL}): Only the horizontal change in (d [symbol] ) is considered.

( [symbol] _{E})=(m_{R})²/(m_{L})²: Simulated area approximation is made for (d [symbol] ).

( [symbol] _{HR})=(m_{HR})(% m_{V R})/(m_{HL})(% m_{V L}): Simulated viewed area is made for (dᵢ).

( [symbol] _{D})=(m_{HR})(m_{V R})(m_{LR})/(m_{HL})(m_{V L})(m_{LL}): Simulated volumetric for (d [symbol] ).

This ( [symbol] ) value is compared to that stored in computer memory, as calculated from the Option-3 Exponential ( [symbol] ) expansion curve shown in FIG. 10, which is our target value for this iteration. Since it is very unlikely that we will have matched these ( [symbol] ) values on the first iterative try, the difference and it's magnitude are noted; wherewith a new value is calculated and selected, based upon proportional analysis, for chordal element fr0. The position is then reiterated, using new fr0 values, as many times as necessary to bring the calculated ( [symbol] ) value within a specified error range of the target ( [symbol] )

This process of multiple iterations is pursued across the entire aspheric surface R2-R5, until point ZRN is reached. Our field-of-view (FOV) target is say 40 degrees, and assume the total FOV attained is 35 degrees. Assume also that the FOV developed across the spherical portion is 5 degrees. This means that we generated only 30 degrees across the aspheric portion, but we needed to generate 35 degrees. Again, by proportional analysis, we go back to FIG. 10 and increase the ( [symbol] ) value R5-W by the ratio of 35/30. The complete iterative process is again pursued, which should then produce results that satisfy all of the proposed mirror's specifications. The final process is then to convert the (X-Y) data thus acquired to a CNC Machine Tool computer format (say MasterCam) and cut the molds and gages as required.

Having described my invention, I claim:

1. An aspheric mirror for mounting on an automotive vehicle in a specified location having line-of-sight relationships from the vehicle Operator's Two Eyes, whereupon the mirror's surface curvature is developed by a multiplicity of constant sight-line angular iterations (Δθ), for a right side mirror application in a left to right direction, as a function of the ratio ( [symbol] ) of the apparent image size seen in the mirror by the right eye divided by the apparent image size seen in the mirror by the left eye; or for a left side mirror application in a right to left direction, as a function of the ratio ( [symbol] ) of the apparent image size seen in the mirror by the left eye divided by the apparent image size seen in the mirror by the right eye; the beginning points for constant line-of-sight angular iterations (Δθ) for a right side mirror being LO for the Left Eye and R0 for the Right Eye, and for a left side mirror being RO for the Right Eye and L0 for the Left Eye, respectively, when reflected lines-of-sight from these two points are parallel to each other and direcred straight rearward to infinity.

2. An aspheric mirror for mounting on an automotive vehicle in a specified location having line-of-sight relationships from the vehicle Operator's Two Eyes, whereupon the mirror's surface curvature is developed by a multiplicity of constant sight-line angular iterations (Δθ), for a right side mirror application in a left to right direction, as a function of the ratio ( [symbol] ) of the magnification factor of the apparent image size seen in the mirror by the right eye divided by the magnification factor of the apparent image size seen in the mirror by the left eye; or for a left side mirror application in a right to left direction, as a function of the ratio ( [symbol] ) of the magnification factor of the apparent image size seen in the miror by the left eye divided by the magnification factor of the apparent image size seen in the mirror by the right eye; wherein the ratio ( [symbol] ) is a function of the instantaneous magnification factors (m-right)/(m-left) for a right side mirror, or (m-left)/(m-right) for a left side mirror, as calculated by the formula: m=(−r)/(2p−(−r)), with the mirror having (r) radius of curvature and the object located (p ) distance from the mirror's reflective surface on a specified Focus Line, which is laterally offset from either the right or left side of the principal vehicle as specified, respectively; the beginning points for constant line-of-sight angular iterations (Δθ) for a right side mirror being L0 for the Left Eye and R0 for the Right Eye, and for a left side mirror being R0 for the Right Eye and L0 for the Left Eye, respectively, when reflected lines-of-sight from these two points are parallel to each other and direcred straight rearward to infinity.

3. The mirror of claim 2, wherein the ratio ( [symbol] )=( [symbol] _{H}) is a function of the instantaneous horizontal magnification factors (m-right)/(m-left) for a right side mirror, or (m-left)/(m-right) for a left side mirror, as calculated for each respective value of (m) by the formula: m=(−r)/(2p−(−r)), with the mirror having (r) radius of curvature and the object located (p) distance from the mirror's reflective surface on a specified Focus Line, which is laterally offset from either the right or left side of the principal vehicle as specified, respectively.

4. The mirror of claim 2, wherein the ratio ( [symbol] )=( [symbol] _{E}) is a function of the instantaneous exponential area approximation magnification factors (m-right)²/(m-left)² for a right side mirror, or (m-left)²/(m-right)² for a left side mirror, as calculated for each respective value of (m) by the formula: m=(−r)/(2p −(−r)), with the mirror having (r) radius of curvature and the object located (p) distance from the mirror's reflective surface on a specified Focus Line, which is laterally offset from either the right or left side of the principal vehicle as specified, respectively.

5. The mirror of claim 2, wherein the ratio ( [symbol] ) =(S_{A}) is a function of the instantaneous simulated viewed area magnification factors ((mH-right) (% mV-right)/(mH-left) (% mV-left)) for a right side mirror, or ((mH-left) (% mV-left)/(mH-right) (% mV-right)) for a left side mirror, as calculated for each respective value of (m) by the formula: m=(−r)/(2p−(−r)), with the mirror having (r) radius of curvature and the object located (p) distance from the mirror's reflective surface on a specified Focus Line, which is laterally offset from either the right or left side of the principal vehicle as specified, respectively; where the % value may range between (0% and 100%).

6. The mirror of claim 2, wherein the ratio ( [symbol] )=(S_{D}) is a function of the instantaneous simulated volume magnification factors ((mH-horizontal) (mV-vertical) (mG-longitudinal)), ie: ((mHR) (mVR) (mGR)/(mHL) (mVL) (MGL)) for a right side mirror, or (mHL) (mVL) (mGL)/(mHR) (mVR) (mGR)) for a left side mirror, as calculated for each respective value of (m) by the formula: m=(−r)/(2p−(−r)), with the mirror having (r) radius of curvature and the object located (p) distance from the mirror's reflective surface on a specified Focus Line, which is laterally offset from either the right or left side of the principal vehicle as specified, respectively; where the horizontal and vertical factors are calculated at a distance (p) to the nearest part of the object, and where the longitudinal factor is calculated at a distance (p) to a chosen point along the objects true length front to rear.

7. The mirrors of claims 1 through 6, having horizontal and vertical datum lines originating at and pasing through the Optical Design Center point L0 for a right side mirror and through said point R0 for a left side mirror, where the points ZRN for a right side mirror and ZLN for a left side mirror are the last points on the peripheral edge of the mirror's surface, whereupon the lines (L0-ZRN) and (R0-ZLN) represent the total distance across the right or left mirror surfaces along the horizontal datum line (Y-Y AXIS) from points L0 or R0, respectively; whereupon the horizontal line (L0-ZRN) or (R0-ZLN) or a portion of either is rotated downward clockwise about Optical Design point L0 for a right side mirror and counterclockwise about Optical Design point R0 for a left side mirror, or any other point as desired, respectively, through any desired angular ray displacement up to 90 degrees to the vertical datum line (X-X axis) through which rotation the slope angles of the mirror's surface (θₙ) are progressively increased to it's peripheral edge point ZRN or ZLN, respectively, whereat (θₙ) is the maximum slope angle of the mirror's surface development, whereupon at the vertical datum line (X-X AXIS) the progression may be reversed or continue in any other manner as desired.

8. The mirrors of claims 1 through 6, having horizontal and vertical datum lines originating at and pasing through the Optical Design Center point L0 for a right side mirror and through said point R0 for a left side mirror, where the points ZRN for a right side mirror and ZLN for a left side mirror are the last points on the peripheral edge of the mirror's surface, whereupon the lines (L0-ZRN) and (R0-ZLN) represent the total distance across the right or left mirror surfaces along the horizontal datum line (Y-Y AXIS) from points L0 or R0, respectively; whereupon the horizontal line (L0-ZRN) or (R0-ZLN) or a portion of either is rotated downward clockwise about Optical Design point L0 for a right side mirror and counterclockwise about Optical Design point R0 for a left side mirror, or any other point as desired, respectively, through any desired angular ray displacement up to 90 degrees to the vertical datum line (X-X axis) through which rotation the slope angles of the mirror's surface (θₙ) remain unchanged, but the line elements (L0-ZRN) or (R0-ZLN) or any segment thereof are progressively foreshortened so as to gradually compress the aspheric surface into a smaller dimension at their peripheral edge points ZRN or ZLN, respectively, whereat (remains the maximum slope angle of the mirror's surface development, whereupon at the vertical datum line (X-X AXIS) the progression may be reversed or continue in any other manner as desired.

9. An inside rearview mirror, incorporating any or all of the optical surface characteristics of those mirror's of claims 1 through 6, enabling said mirror to be able to reflect straight rearward through the rear window, and/or through the right side windows, and/or through the left side windows, of the vehicle; which mirror surface is developed about a nominally centrally located vertical line on it's surface, and the right and left peripheral surfaces of the mirror are developed independently of eachother while sharing a common flat or spherical center portion; or either the right or left peripheral surface is developed, which is then transfered to the opposite side, thus comprising a symmetrically shaped mirror surface.

10. A fender mounted mirror, applied primarilly to Tractors of Heavy Truck Tractor-Trailer type vehicles and to conventional Straight-Truck types, but not limited thereto, having any or all optical characteristics as disclosed in claims 1 through 8, which mirror may be designed specifically for either the left or right side location, and is designed to observe road surface areas immediately in front of and along side of the front wheels of the Tractor/Truck, as well as rearward toward or beyond the driving wheels of the Tractor/Truck.

11. For mirrors of claims 1 through 10, materials for construction of the mirrors may be glass, metal, plastic, or any other material suited to a specific application; and said mirrors may be coated and/or constructed in such a way as to provide, but not limited to: standard reflectivity, color tinted surfaces, electrochromatic or other light sensitive dimming characteristics, manual or automatic day/night flip dimming capability, etc.

12. For mirrors of claims 1 through 11, Molds, supporting Fixtures, and Gages, are disclosed, and may be of slump bending, press bending, injection molding, thermal-forming, or other types, all of which are fabricated to the optical specifications of any of these claims; for which, if the mirror is a front (first) surface reflector, the female mold portion is formed substantially to the X-Y data evolved by the processes herein disclosed, and the male portion is formed to X-Y values that compensate for the mirror substrate thickness and for any buffering glass cloth (or otherwise) material introduced between the material being molded, or otherwise formed, and the mold itself.

13. For mirrors of claims 1 through 10, the ( [symbol] ) factor is calculated as a straight line function as shown in FIG. 10, beginning at the end of the spherical portion or for the full width of the mirror if no spherical portion is used.

14. For mirrors of claims 1 through 10, the ( [symbol] ) factor is calculated, as shown in FIG. 10, beginning at the end of the spherical portion or for the full width of the mirror if no spherical portion is used, beginning as a circular arc with a straight line depending therefrom.

15. For mirrors of claims 1 through 10, the [symbol] ) factor is calculated as an exponential or other geometric curve expansion beginning at the end of the spherical portion, or for the full mirror width if no spherical portion is used.

16. For mirrors of claims 13, 14, and 15, where at any point the positive geometric expansion rate of the ( [symbol] ) curve begins to slow down and may even eventually reverse itself, becoming negative, thereby slowing down the rate of decrease in the ( [symbol] ) value, even to the point of causing the ( [symbol] ) value to begin increasing.
